(19) United States
(12) Patent Application Publication
(10) Pub. No.: US 2014/0279228 A1
(43) Pub. Date: Sep. 18, 2014

(54) SYSTEM AND METHOD FOR PROVIDING ONLINE AUTHENTICATION CODES USABLE TO PURCHASE GOODS AND/OR SERVICES

(71) Applicant: MONEYGRAM INTERNATIONAL, INC., Dallas, TX (US)

(72) Inventors: Jessica Amy Fry, Denver, CO (US); Amy Joyce Brown, Aurora, CO (US); Billy Joe Steiger, Ovilla, TX (US)

(73) Assignee: MONEYGRAM INTERNATIONAL, INC., Dallas, TX (US)

(21) Appl. No.: 13/832,827

(22) Filed: Mar. 15, 2013

(51) Int. Cl. G06Q 30/06

(52) U.S. Cl. CPC G06Q 30/0613
USPC 705/26.41

(57) ABSTRACT

A method for providing online authentication codes usable to purchase good and/or services. A plurality of authentication codes that can be provided to third party receiving entities are stored in a database. The third party receiving entities provide goods and/or services that can be obtained through presentment of the authentication codes to the third party receiving entities. An electronic request is received from a third party sender via an interface to purchase and receive an authentication code that can be presented to a third party receiving entity in return for a good and/or service from the third party receiving entity. An identity of a receiving entity for the requested authentication code is received from the third party sender through an interface. Payment for the authentication code is received from the sender. The authentication code is provided to the sender after receiving the payment. A portion of the payment received from the sender is provided to the third party receiving entity after receiving payment from the sender for the authentication code.

### TECHNICAL FIELD

The present disclosure relates generally to financial transaction processing systems such as money transfer systems. More specifically, the present disclosure relates to purchasing of unlock or authentication codes via a financial transaction processing system.

### BACKGROUND

Businesses operate financial transaction processing systems to offer money transfer and other services through a network of agents and computers. A consumer that desires to use these services to send or transfer money to a third party takes the money to one of the agents or computers associated with the business. The agent or computer accepts the money, obtains necessary information such as the consumer's identity and the identity of the third party transferee, and initiates a transaction. The money is then made available to the third party transferee or receiver by another agent or another computer.

In some cases, the third party to receive the money transfer is a company or organization providing a good or service to the money transfer consumer. In this arrangement, the consumer can purchase the good or service from the company or organization without having a bank account or credit card to make the purchase. For example, the consumer can bring cash or a money order to an agent or computer associated with the money transfer business to effect payment for the good or service from the company or organization.

### SUMMARY

In one aspect, the present disclosure relates to method for operating a financial transaction processing system. The method includes storing in a database a plurality of authentication codes that can be provided to third party receiving entities, wherein the third party receiving entities provide goods and/or services that can be obtained through presentment of the authentication codes. An electronic request is received from a third party sender via an interface to purchase and receive an authentication code that can be presented to a third party receiving entity in return for a good and/or service from the third party receiving entity. An identity of a receiving entity for the requested authentication code is received from the third party sender through an interface. Payment for the authentication code is received from the sender. The authentication code is provided to the sender after receiving the payment. A portion of the payment received from the sender is provided to the third party receiving entity after receiving payment from the sender for the authentication code.

In another aspect, the disclosure relates to a financial transaction system including a database storing authentication codes associated with goods and/or services that can be provided by third party receiving entities. The third party receiving entities provide the goods and/or services that can be obtained through presentment of the authentication codes. The interface is configured to receive a request from a third party sender to purchase and receive an authentication code that can be presented to a third party receiving entity in return for a good and/or service from the third party receiving entity, and to receive payment information reflecting payment by the sender for the authentication code. A server is coupled to the database and the interface. The server is configured to (1) process the authentication code request, (2) provide the authentication code to the sender through the interface after the payment information reflects payment for the authorization code, and (3) initiate payment of at least a portion of the payment received from the sender to the third party receiving entity after the payment information reflects payment for the authorization code.

In a further aspect, the present disclosure relates to a method for operating a financial transaction processing system. The method includes receiving a plurality of authentication codes from a plurality of third party receiving entities, and storing the codes in an authentication code database. Each authentication code is usable to redeem a good and/or service from one of the third party receiving entities. A request is received from a third party sender via an interface to purchase an authentication code. The request identifies the good and/or service to be purchased and/or the third party receiving entity providing the good and/or service. The system determines whether the system is capable of providing the requested authentication code, and provides a message to the sender indicating that an authorization code cannot be provided if the system is not capable of providing the code. A price for the good and/or service identified in the request is determined. Information representing payment for the authorization code is received from the sender, the payment including the price of the good and/or service. An authentication code associated with the good and/or service and/or third party receiving entity identified in the request is retrieved from the authentication code database. The authentication code is provided to the sender after receiving the payment information. Payment to the third party receiving entity of at least a portion of the payment received from the sender is initiated after receiving payment from the sender for the authentication code.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a block diagram of an embodiment of a system for receiving an processing requests and providing authentication or unlock codes for purchased goods or services.

FIG. 2 is a flow diagram of steps in a method for providing a sender with an authentication or unlock code, according to an embodiment of the present disclosure.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

FIG. 1 is a block diagram of an embodiment of a system 10 for processing requests and providing authentication or unlock codes for goods and/or services purchased by third party senders (i.e., authorization code purchasers). System 10 includes a point of sale device such as send computer 12 at a purchase or send location 14 and receiving entities 16 including entities 1, 2, . . . N. The receiving entities 16 are third parties that offer and can provide goods and/or services to the third party senders in response to the receipt of the purchased authorization codes. The send computer 12 and the receiving entities 16 communicate with a central server 20 (e.g., through an interface at the central server), for example via a communication network 21, such as the internet. In some embodiments, a sender interface 22 is connected to the send computer 12, and a server computer 26 is connected to the server 20. The system 10 facilitates, in part, the receipt of requests and sending of authorization codes through the send computer 12, and the receipt and delivery of information regarding the authorization codes to the receiving entities 16.

The send location 14 may be a facility that is approved by a financial services organization to send purchase requests for authorization codes to the server 20 (i.e., to stage a purchase or send transaction). In embodiments, the send location 14 may be a store or dedicated location that provides redemption services for money transfers. Alternatively, the send location 14 may access a computer remotely, such as via a telephone call or the internet. The send computer 12 is operated by an agent at the approved send location 14 in some embodiments. The send computer 12 may include software that facilitates entry of information via the sender interface 22 to request sending the authorization code for subsequent transmission to the server 20 for approval. The agent at the send location 14 may also review purchaser identification and accept funds from the sender. In some embodiments, the agent accepts funds on behalf of the financial services organization operating the system 10. The send location 14 may also include a telephone (not shown) or other voice communications device to contact the financial services organization if questions arise during the authorization code request process. In other embodiments the customer can call an agent over the telephone and provide the agent with information needed to stage the authorization code send or purchase transaction over the telephone, or input information directly using an interface (e.g., at a kiosk). In these embodiments the customer can then go to an agent location to complete the send transaction staging operation (e.g., to provide the agent with the payment). While a single send location 14 is shown in FIG. 1, in actual implementation, the system 10 includes a plurality of send locations 14 that each includes a send computer 12 that communicates with the server 20.

In alternative embodiments, the send computer 12 may be any computer configured to provide information to the server 20 via a secure internet or server connection. For example, the send computer 12 may be a home computer (e.g. computer 32), kiosk, or other interactive device with an associated sender interface (e.g., keyboard, touch screen). The send computer 12 may include a web browser or other application that provides a user interface to enter information to send an authorization code request. The web browser may allow for entry of sender identification information and sender account information, the latter of which authorizes withdrawal of funds from an account with a financial institution to fund the authorization code purchase. As another example, and as discussed above, the send computer 12 may be configured to receive purchase request information from the sender via telephone (e.g. telephone 34) or interactive voice recognition systems. As a further example, a telephone at the send location 14 may be used to contact a call center (not shown) to stage or initiate a send request to the server 20. The send computer 12 may also be located remotely from the send location 14. When staging a send transaction the customer will typically provide information such as their identity, and information such as the name and location of the receiver, and/or information representative of the good and/or service associated with the authorization code being purchased, and receive a receipt. The operator of the financial transaction processing system will typically create a record of the send transaction (e.g., at the server computer 26).

The receiving entities 16 are organizations or businesses that provide goods and/or services that can be purchased, and may have contractual arrangements with the operator of the system 10 relating to the authorization code providing services described herein. The receiving entities 16 can each provide descriptions of available goods and services available for purchase in a format that is reviewable by the authorization code purchaser. For example, the receiving entities 16 may provide websites including product or service listings. Alternatively, the financial services organization can provide a catalog or website that collectively lists all goods and services available for purchase through the system 10 and/or lists associated receiving entities 16 for which authorization codes can be purchased through the system 10. The receiving entities 16 may provide any type of good or service, including, but not limited to, software, music, electronic books, concert tickets, special event reservations, movie tickets, baggage fees, transportation fare, sporting event tickets, park fees, subscription services, portable electronic device applications, movie rentals, monthly delivery clubs, and the like. As will be described in more detail herein, the system 10 is configured to provide the sender with an authentication code or unlock code to redeem a good or service from a receiving entity 16 in exchange for a payment from the sender to pay for the good or service.

The server 20 may be housed and/or operated by or on behalf of the financial services organization that, among other functions, approves and coordinates transactions at the send location 14 and transfer of associated information to the receive entities 16. The server 20 facilitates approval of send requests from the send location 14. In some embodiments, the server 20 is configured to process transactions automatically. In other embodiments, the server 20 provides information to a user at the financial services organization for review and approval. For example, the server 20 may be connected to a computer 26 that provides an interface to a user at the financial services organization to review and approve or deny transaction requests. In some embodiments, the server 20 provides governmental or other regulatory body compliance functions. The server 20 includes storage capabilities to store information for later retrieval and transmission. In addition, the server 20 may store other information such as, for example, past customer send/receive activity, customer account information, and computer identification and log-in information for the send computer 12 and receiving entities 16. The information for a customer may be stored in the server 20 as a customer or user profile.

As will be discussed in more detail herein, the system 10 is configured to facilitate the purchase of goods or services provided by the receiving entities 16 by providing an authentication or unlock code to a sender in exchange for payment. The authentication or unlock code is then usable or submittable to the receiving entity providing the good or service associated with the authentication or unlock code to redeem the good or service. The authentication or unlock codes are stored in an authentication code database 36 that communicates with the server 20. The authentication code database 36 stores the codes, e.g., until provided to a purchaser following the completion (including payment) of the transaction, or until the codes are provided by the sender to a receiving entity 16 in return for goods or services. The codes may be provided by the receiving entities 16 for storage in the authentication code database 36 (e.g., before the specific sender purchase request), or the codes may be generated by the financial services organization that operates the system 10. Alternatively, the authentication or unlock codes can be generated by the system 10 (and provided to the receiving entity 16) during or after the purchase transaction with the sender, e.g., when the transaction with the sender is completed.

The system 10, including the send locations 14 and receiving entities 16, can be implemented in any of a wide range of forms. In embodiments, for example, the services and processes provided by features of the system 10 can be provided by associated features of a money transfer system. Examples of such systems that can be used in accordance with the methods and systems described herein are disclosed in the Bennett et al. U.S. Patent Application Publication 2009/0106149 entitled Global Compliance Processing System For A Money Transfer System, the Fulton et al. U.S. Patent Application Publication 2012/0036071 entitled Verification Methods For Fraud Prevention In Money Transfer Receive Transactions, the Sander et al. U.S Patent Application Publication 2010/0100426 entitled Agent Management System, the Scribner et al. U.S. Patent Application Publication 2009/0063261 entitled Consumer Database Loyalty Program For A Money Transfer System, and U.S. Patent Application Publication 2008/0140568 entitled Method And Apparatus For Distribution Of Money Transfers. The above-identified U.S. patent application publications are incorporated herein by reference for all purposes. Features and functionality disclosed in the above-identified publications can be used in connection with or as part of the system 10.

FIG. 2 is a flow diagram of steps in an exemplary method for providing a sender with an authentication or unlock code, according to an embodiment of the present disclosure. In step 50, the server 20 receives a request from the sender on a send computer to send an authentication code. The request may be sent via the send computer 12 at the send location 14, or via another point of sale device such as the sender's computer 32, telephone 34, or the computer or other interface of an agent that the customer interacted with to stage the send transaction. For example, the computer 32 or telephone 34 may include a webpage or application configured to initiate an authentication code purchase request in the system 10. The send amount is the amount of money to pay for the good or service desired from one of the receiving entities 16. The request may also include additional information, such as the sender's identification information and, in some cases, an account from which the funds for the payment will be drawn.

In step 52, the sender is prompted to identify the receiving entity 16 that is to provide the desired good or service. In some embodiments, the sender identifies the good or service desired, and the server 20 determines the associated receiving entity 16. The sender can be prompted by an agent at the send location 14 operating the send computer 12, or the sender can be prompted on the computer 32 or telephone 34 used to stage the authentication code send transaction.

In step 54, payment is received from the sender for the authentication code as funding for the good or service. For example, if the sender initiates the transaction via the computer 32 or telephone 34, the sender can bring funds for the payment to a send location 14 and provide the funds to an agent at the send location 14. In this case, the agent retrieves the transaction record from the server 20 and records that the money is paid for upon receiving the funds. In cases in which the sender initiates the transaction at the send location 14, the agent can collect the funds to complete the send transaction. When the payment has been received from the sender, the system 10 can initiate payment to the receiving entity associated with the authentication code. For example, the system 10 can initiate and electronic funds transfer to a financial account of the receiving entity. The operator of the system 10 may charge the receiving entity or the purchaser a fee for the authorization code and the services provided in connection with the operation of the system and the provision of the code.

In step 56, after the payment is received, the server 20 retrieves an authentication (or unlock) code associated with the good or service from the authentication code database 36. The authentication code can have a format (e.g., string of alphanumeric characters) that is particular to the receiving entity 16 providing the good or service and/or to the particular good or service the sender desires to purchase. In alternative embodiments, the server 20 generates and stores the authentication code during completion of the transaction. Server 20 can communicate information regarding authentication codes (e.g., information regarding codes for which payments have been received) to the associated receiving entities 16. For example, a receiving entity 16 that receives a code from a customer as payment for a good or service may submit an electronic authorization request to the server 20. In response, the server 20 can provide a reply indicating whether the code is legitimate and paid for.

In step 58, the sender is provided with the authentication code, which can be used to redeem the good or service purchased with the money transfer. In some embodiments, the send computer 12 is used to print a receipt including the authentication code. In other embodiments, an electronic message (e.g., text message or email) is sent to the sender including a display of the authentication code. In some embodiments the sender may write or otherwise record the displayed code for later use. The sender may also be provided with instructions with the authentication code for steps for using the authentication code. For example, in some embodiments, the sender may be directed to a website or mobile device application operated by the receiving entity to enter the authentication code. When the authentication code has been provided to the receiving entity 16, the receiving entity 16 makes the good or service available to the sender. For example, the receiving entity 16 can ship or electronically transmit the good purchased with the code to the sender when the sender enters or otherwise provides a valid authentication code.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

We claim:

1. A method for operating a financial transaction processing system, the method comprising:
storing in a database a plurality of authentication codes that can be provided to third party receiving entities, wherein the third party receiving entities provide goods and/or services that can be obtained through presentment of the authentication codes to the third party receiving entities;
receiving an electronic request from a third party sender via an interface to purchase and receive an authentication code that can be presented to a third party receiving entity in return for a good and/or service from the third party receiving entity;
receiving from the sender via the interface an identity of a receiving entity for the requested authentication code;
receiving payment from the sender for the authentication code;
providing the authentication code to the sender after receiving the payment; and
providing a portion of the payment received from the sender to the third party receiving entity after receiving payment from the sender for the authentication code.

2. The method of claim 1, and further comprising:
accessing a database to determine if the system is capable of providing the requested authentication code; and
providing a message to the sender indicating the inability to provide the requested authentication code if the system is not capable of providing the code.

3. The method of claim 1, wherein the authentication code is enterable on a computer by the sender to initiate receipt of the good and/or service from the third party receiving entity.

4. The method of claim 1, wherein providing the authentication code comprises:
printing a receipt for the sender including the authentication code.

5. The method of claim 1, wherein providing the authentication code comprises:
generating an electronic message to the sender including the authentication code.

6. The method of claim 1, and further comprising:
providing instructions to the sender for redeeming the good and/or service associated with the authentication code.

7. The method of claim 6, wherein providing instructions to the sender comprises:
directing the sender to a website associated with the receiving entity.

8. The method of claim 1, and further comprising:
prompting the sender on the send computer to identify the receiving entity.

9. The method of claim 1, and further including one or more of generating and storing the authentication code in connection with the request processing, and receiving the authentication code from the receiving entity before receiving the request.

10. The method of claim 1 and further including providing to receiving entities electronic messages regarding the issuance of authorization codes.

11. The method of claim 10 and further including receiving requests for information about authorization codes from receiving entities.

12. A financial transaction processing system comprising:
a database storing authentication codes associated with goods and/or services that can be provided by third party receiving entities, wherein the third party receiving entities provide the goods and/or services that can be obtained through presentment of the authentication codes to the third party receiving entities;
an interface configured to receive a request from a third party sender to purchase and receive an authentication code that can be presented to a third party receiving entity in return for a good and/or service from the third party receiving entity, and to receive payment information reflecting payment by the sender for the authentication code; and
a server coupled to the database and the interface, the server configured to (1) process the authentication code request, (2) provide the authentication code to the sender through the interface after the payment information reflects payment for the authorization code, and (3) initiate payment of at least a portion of the payment received from the sender to the third party receiving entity after the payment information reflects payment for the authorization code.

13. The system of claim 1, wherein the server is further configured to (4) access the database to determine if the system is capable of providing the requested authentication code, and (5) provide a message to the sender through the interface indicating the inability to provide the requested authentication code if the system is not capable of providing the code.

14. The system of claim 12, wherein the authentication code is enterable on a computer by the sender to initiate receipt of the good and/or service from the receiving entity.

15. The system of claim 12, wherein the system is further configured to provide a receipt for the sender including the authentication code.

16. The system of claim 12, wherein the system is further configured to provide instructions to the sender for redeeming the good and/or service associated with the authentication code.

17. The system of claim 16, wherein the instructions direct the sender to a website associated with the receiving entity.

18. The system of claim 12, wherein the interface prompts the sender to identify the receiving entity.

19. The system of claim 12 wherein the server is configured to receive the identification codes from the third party receiving entities before the request processing, and to retrieve the authentication code from the database.

20. The system of claim 12 wherein the server is configured to provide to receiving entities electronic messages regarding the issuance of authorization codes.

21. The system of claim 12 wherein the server is configured to receive requests for information about authorization codes from receiving entities.

22. The system of claim 12 wherein the server is configured to generate and store the authentication code in connection with the request processing.

23. A method for operating a financial transaction processing system, the method comprising:
receiving a plurality of authentication codes from a plurality of third party receiving entities, and storing the codes in an authentication code database, each authentication code usable to redeem a good and/or service from one of the third party receiving entities;
receiving a request from a third party sender via an interface to purchase an authentication code, the request identifying the good and/or service to be purchased and/or the third party receiving entity providing the good and/or service;
determining whether the system is capable of providing the requested authentication code;
providing a message to the sender indicating that an authorization code cannot be provided if the system is not capable of providing the code;
determining a price for the good and/or service identified in the request;
receiving information representing payment for the authorization code from the sender, the payment including the price of the good and/or service;
retrieving an authentication code associated with the good and/or service and/or third party receiving entity identified in the request from the authentication code database; and
providing the authentication code to the sender after receiving the payment information; and
initiating payment of at least a portion of the payment received from the sender to the third party receiving entity after receiving payment from the sender for the authentication code.

24. The method of claim 23 and further including providing to receiving entities electronic messages regarding the issuance of authorization codes.

25. The method of claim 24 and further including receiving requests for information about authorization codes from receiving entities.
